(19) United States
(12) Patent Application Publication
(10) Pub. No.: US 2026/0254605 A1
(43) Pub. Date: Aug. 27, 2026

(54) COORDINATED MULTI-USER DYNAMIC SUB-BAND FULL DUPLEX FOR ULTRA WIDE BAND

(71) Applicant: QUALCOMM Incorporated, San Diego, CA (US)

(72) Inventors: Alexander SVERDLOV, Rehovot (IL); Peer BERGER, Hod Hasharon (IL); Shay LANDIS, Hod Hasharon (IL); Guy WOLF, Rosh Haayin (IL); Michael LEVITSKY, Rehovot (IL)

(21) Appl. No.: 19/159,206

(22) PCT Filed: Mar. 1, 2024
(86) PCT No.: PCT/US2024/018046

§ 371 Date: Aug. 22, 2025

(30) Foreign Application Priority Data
Apr. 27, 2023 (IL) 302459

(51) Int. Cl. H04L 5/14; H04L 5/00

(52) U.S. Cl. CPC H04L 5/14; H04L 5/0094

(57) ABSTRACT

Methods, systems, and devices for wireless communications are described. Sub-band full-duplex (SBFD) communications using ultra wide band (UWB) may be coordinated for multiple users. A first wireless communication device may receive, from a first user equipment (UE), a request for resources for SBFD with a second wireless communications device. The first wireless communication device may transmit, based on the capability of the first UE and in response to the request, control signaling indicating a first frequency band for signaling from the first UE to the second wireless communications device and a second frequency band for signaling from the second wireless communications device to the first UE. The first frequency band and the second frequency band are separated by a third frequency band that is allocated, by the first wireless communications device, for SBFD communication between a second UE and a third wireless communications device.

### CROSS REFERENCE

The present Application is a 371 national stage filing of International PCT Application No. PCT/US2024/018046 by SVERDLOV et al., entitled “COORDINATED MULTI-USER DYNAMIC SUB-BAND FULL DUPLEX FOR ULTRA WIDE BAND,” filed Mar. 1, 2024; and claims priority to Israel Patent Application No. 302459 by SVERDLOV et al., entitled “COORDINATED MULTI-USER DYNAMIC SUB-BAND FULL DUPLEX FOR ULTRA WIDE BAND,” filed Apr. 27, 2023, each of which is assigned to the assignee hereof, and each of which is expressly incorporated by reference in its entirety herein.

### FIELD OF TECHNOLOGY

The following relates to wireless communications, including coordination among multiple users using dynamic sub-band full duplex for ultra wide band communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support coordinated multi-user dynamic sub-band full duplex (SBFD) for ultra wide band (UWB) communications. In a network implemented coordination procedure, a network entity or a master user equipment (UE) may coordinate SBFD of the UWB for communication between one or more UEs and one or more wireless communications devices (e.g., extended reality (XR) devices). The coordinating device (e.g., the network entity or the UE) may receive an indication of an SBFD capability of the UE or a capability of the wireless communication device. When the coordinating device receives a request for communication resources for SBFD communications between the UE and the wireless communication device, the coordinating device may indicate an SBFD configuration to the UE. The configuration may indicate SBFD sub-bands which the UE and the wireless communication device may use for communications. The allocation of the sub-bands to the UE and wireless communication device pair may be such that the coordinating device is also able to allocate intervening sub-bands to another UE and wireless communication device pair.

A method for wireless communication at a first wireless communications device is described. The method may include receiving, from a first UE, an indication of a capability of the first UE to support SBFD communication with a second wireless communications device, receiving, from the first UE, a request for resources for the SBFD communication with the second wireless communications device, and transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

An apparatus for wireless communication at a first wireless communications device is described. The apparatus may include a processor, memory coupled with the processor, and instructions stored in the memory. The instructions may be executable by the processor to cause the apparatus to receive, from a first UE, an indication of a capability of the first UE to support SBFD communication with a second wireless communications device, receive, from the first UE, a request for resources for the SBFD communication with the second wireless communications device, and transmit, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

Another apparatus for wireless communication at a first wireless communications device is described. The apparatus may include means for receiving, from a first UE, an indication of a capability of the first UE to support SBFD communication with a second wireless communications device, means for receiving, from the first UE, a request for resources for the SBFD communication with the second wireless communications device, and means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

A non-transitory computer-readable medium storing code for wireless communication at a first wireless communications device is described. The code may include instructions executable by a processor to receive, from a first UE, an indication of a capability of the first UE to support SBFD communication with a second wireless communications device, receive, from the first UE, a request for resources for the SBFD communication with the second wireless communications device, and transmit, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

Some examples of the method, apparatuses, and non-transitory computer-readable medium described herein may further include operations, features, means, or instructions for receiving an indication, from a network entity, that the first wireless communications device may be a master UE and transmitting, in response to receiving the indication that the first wireless communications device may be the master UE, a beacon indicating that the first wireless communications device may be the master UE, where the indication of the capability may be received at the first wireless communications device in response to the beacon.

Some examples of the method, apparatuses, and non-transitory computer-readable medium described herein may further include operations, features, means, or instructions for determining that the first wireless communications device may be a master UE based on a failure to detect a beacon from another UE and transmitting, in response to determining that the first wireless communications device may be the master UE, the beacon indicating that the first wireless communications device may be the master UE, where the indication of the capability may be received at the first wireless communications device in response to the beacon.

Some examples of the method, apparatuses, and non-transitory computer-readable medium described herein may further include operations, features, means, or instructions for receiving, from the first UE, an indication of a second capability of the second wireless communications device to support SBFD communication, where the control signaling may be further based on the second capability of the second wireless communications device.

In some examples of the method, apparatuses, and non-transitory computer-readable medium described herein, receiving the indication of the capability may include operations, features, means, or instructions for receiving an indication of a supported minimum frequency gap for transmission and reception, where a frequency separation between the first frequency band and the second frequency band may be based on the supported minimum frequency gap.

In some examples of the method, apparatuses, and non-transitory computer-readable medium described herein, the first wireless communications device may be a master UE and the indication of the capability, the request for resources, and the control signaling may be communicated via a licensed sidelink communication link.

In some examples of the method, apparatuses, and non-transitory computer-readable medium described herein, the first wireless communications device may be a network entity and the indication of the capability, the request for resources, and the control signaling may be communicated via a licensed access communication link.

Some examples of the method, apparatuses, and non-transitory computer-readable medium described herein may further include operations, features, means, or instructions for receiving, from the second UE, a second indication of a second capability of the second UE to support the SBFD communication with the third wireless communications device, receiving, from the second UE, a second request for resources for communication with the third wireless communications device, and transmitting, to the second UE based on the second capability of the second UE and in response to the request, control signaling indicating the third frequency band for signaling from the second UE to the third wireless communications device and a fourth frequency band for signaling from the third wireless communications device to the second UE.

In some examples of the method, apparatuses, and non-transitory computer-readable medium described herein, the second wireless communications device includes an extended reality entity.

In some examples of the method, apparatuses, and non-transitory computer-readable medium described herein, receiving the request may include operations, features, means, or instructions for receiving an indication of a relative priority of a combination of the first frequency band and the second frequency band with respect to other combinations of frequency bands, where the first frequency band and the second frequency band may be based on the relative priority.

In some examples of the method, apparatuses, and non-transitory computer-readable medium described herein, receiving the request may include operations, features, means, or instructions for receiving an indication of a first traffic condition associated with signaling from the first UE to the second wireless communications device and a second traffic condition associated with signaling from the second wireless communications device to the first UE, where the first frequency band and the second frequency band may be based on the first traffic condition and the second traffic condition.

A method for wireless communications at a UE is described. The method may include transmitting, to a first wireless communications device, an indication of a capability of the UE to support SBFD communication with a second wireless communications device, transmitting, to the first wireless communications device, a request for resources for the SBFD communication with the second wireless communications device, receiving, from the first wireless communications device based on the capability of the UE and in response to the request, control signaling indicating a first frequency band for signaling from the UE to the second wireless communications device and a second frequency band for signaling from the second wireless communications device to the UE, and communicating with the second wireless communications device via the first frequency band and the second frequency band.

An apparatus for wireless communications at a UE is described. The apparatus may include a processor, memory coupled with the processor, and instructions stored in the memory. The instructions may be executable by the processor to cause the apparatus to transmit, to a first wireless communications device, an indication of a capability of the UE to support SBFD communication with a second wireless communications device, transmit, to the first wireless communications device, a request for resources for the SBFD communication with the second wireless communications device, receive, from the first wireless communications device based on the capability of the UE and in response to the request, control signaling indicating a first frequency band for signaling from the UE to the second wireless communications device and a second frequency band for signaling from the second wireless communications device to the UE, and communicate with the second wireless communications device via the first frequency band and the second frequency band.

Another apparatus for wireless communications at a UE is described. The apparatus may include means for transmitting, to a first wireless communications device, an indication of a capability of the UE to support SBFD communication with a second wireless communications device, means for transmitting, to the first wireless communications device, a request for resources for the SBFD communication with the second wireless communications device, means for receiving, from the first wireless communications device based on the capability of the UE and in response to the request, control signaling indicating a first frequency band for signaling from the UE to the second wireless communications device and a second frequency band for signaling from the second wireless communications device to the UE, and means for communicating with the second wireless communications device via the first frequency band and the second frequency band.

A non-transitory computer-readable medium storing code for wireless communications at a UE is described. The code may include instructions executable by a processor to transmit, to a first wireless communications device, an indication of a capability of the UE to support SBFD communication with a second wireless communications device, transmit, to the first wireless communications device, a request for resources for the SBFD communication with the second wireless communications device, receive, from the first wireless communications device based on the capability of the UE and in response to the request, control signaling indicating a first frequency band for signaling from the UE to the second wireless communications device and a second frequency band for signaling from the second wireless communications device to the UE, and communicate with the second wireless communications device via the first frequency band and the second frequency band.

Some examples of the method, apparatuses, and non-transitory computer-readable medium described herein may further include operations, features, means, or instructions for receiving a beacon indicating that the first wireless communications device may be a master UE, where the indication of the capability may be transmitted in response to the beacon.

Some examples of the method, apparatuses, and non-transitory computer-readable medium described herein may further include operations, features, means, or instructions for transmitting, to the first wireless communications device, an indication of a second capability of the second wireless communications device to support SBFD communication, where the control signaling may be further based on the second capability of the second wireless communications device.

Some examples of the method, apparatuses, and non-transitory computer-readable medium described herein may further include operations, features, means, or instructions for receiving, from the second wireless communications device, the indication of the second capability.

In some examples of the method, apparatuses, and non-transitory computer-readable medium described herein, transmitting the indication of the capability may include operations, features, means, or instructions for transmitting an indication of a supported minimum frequency gap for transmission and reception, where a frequency separation between the first frequency band and the second frequency band may be based on the supported minimum frequency gap.

In some examples of the method, apparatuses, and non-transitory computer-readable medium described herein, the first wireless communications device may be a master UE, the indication of the capability, the request for resources, and the control signaling may be communicated via a licensed sidelink, and the SBFD communication via the first frequency band and the second frequency band may be via an UWB communications link.

In some examples of the method, apparatuses, and non-transitory computer-readable medium described herein, the first wireless communications device may be a network entity, the indication of the capability, the request for resources, and the control signaling may be communicated via a licensed access link, the first wireless communications device may be a network entity, and the SBFD communication via the first frequency band and the second frequency band may be via an UWB communications link.

In some examples of the method, apparatuses, and non-transitory computer-readable medium described herein, transmitting the request may include operations, features, means, or instructions for transmitting an indication of a relative priority of a combination of the first frequency band and the second frequency band with respect to other combinations of frequency bands, where the first frequency band and the second frequency band may be based on the relative priority.

Some examples of the method, apparatuses, and non-transitory computer-readable medium described herein may further include operations, features, means, or instructions for performing a channel estimation procedure on a channel between the UE and the second wireless communications device, where the relative priority may be based on the channel estimation procedure.

In some examples of the method, apparatuses, and non-transitory computer-readable medium described herein, transmitting the request may include operations, features, means, or instructions for transmitting an indication of a first relative traffic condition associated with signaling from the UE to the second wireless communications device and a second relative traffic condition associated with signaling from the second wireless communications device to the UE with respect to other traffic conditions associated with other signaling, where the first frequency band and the second frequency band may be based on the first traffic condition and the traffic condition.

In some examples of the method, apparatuses, and non-transitory computer-readable medium described herein, the second wireless communications device includes an extended reality device.

A method for wireless communication at a second wireless communications device is described. The method may include transmitting, to a UE, an indication of a capability of the second wireless communications device to support SBFD communication with the UE, receiving, from the UE based on the capability of the second wireless communications device, control signaling indicating a first frequency band for signaling from the UE to the second wireless communications device and a second frequency band for signaling from the second wireless communications device to the UE, and communicating with the UE via the first frequency band and the second frequency band.

An apparatus for wireless communication at a second wireless communications device is described. The apparatus may include a processor, memory coupled with the processor, and instructions stored in the memory. The instructions may be executable by the processor to cause the apparatus to transmit, to a UE, an indication of a capability of the second wireless communications device to support SBFD communication with the UE, receive, from the UE based on the capability of the second wireless communications device, control signaling indicating a first frequency band for signaling from the UE to the second wireless communications device and a second frequency band for signaling from the second wireless communications device to the UE, and communicate with the UE via the first frequency band and the second frequency band.

Another apparatus for wireless communication at a second wireless communications device is described. The apparatus may include means for transmitting, to a UE, an indication of a capability of the second wireless communications device to support SBFD communication with the UE, means for receiving, from the UE based on the capability of the second wireless communications device, control signaling indicating a first frequency band for signaling from the UE to the second wireless communications device and a second frequency band for signaling from the second wireless communications device to the UE, and means for communicating with the UE via the first frequency band and the second frequency band.

A non-transitory computer-readable medium storing code for wireless communication at a second wireless communications device is described. The code may include instructions executable by a processor to transmit, to a UE, an indication of a capability of the second wireless communications device to support SBFD communication with the UE, receive, from the UE based on the capability of the second wireless communications device, control signaling indicating a first frequency band for signaling from the UE to the second wireless communications device and a second frequency band for signaling from the second wireless communications device to the UE, and communicate with the UE via the first frequency band and the second frequency band.

In some examples of the method, apparatuses, and non-transitory computer-readable medium described herein, transmitting the indication of the capability may include operations, features, means, or instructions for transmitting, to the UE, an indication of a supported minimum frequency gap for transmission and reception, where a frequency separation between the first frequency band and the second frequency band may be based on the supported minimum frequency gap.

In some examples of the method, apparatuses, and non-transitory computer-readable medium described herein, the indication of the capability and the control signaling may be via an unlicensed sidelink communication link and the SBFD communication via the first frequency band and the second frequency band may be via an UWB communication link.

In some examples of the method, apparatuses, and non-transitory computer-readable medium described herein, the second wireless communications device includes an extended reality device.

In some examples of the method, apparatuses, and non-transitory computer-readable medium described herein, the indication of the capability and the control signaling may be communicated via a licensed access communication link between the second wireless communication device and the UE.

### BRIEF DESCRIPTION OF THE DRAWINGS

FIG. 1 shows an example of a wireless communications system that supports coordinated multi-user dynamic sub-band full duplex (SBFD) for ultra wide band (UWB) in accordance with one or more aspects of the present disclosure.

FIG. 2 shows another example of a wireless communication system that supports coordinated multi-user dynamic SBFD for UWB in accordance with one or more aspects of the present disclosure.

FIG. 3 shows an example of a process flow that supports coordinated multi-user dynamic SBFD for UWB in accordance with one or more aspects of the present disclosure.

FIG. 4 shows another example of a process flow that supports coordinated multi-user dynamic SBFD for UWB in accordance with one or more aspects of the present disclosure.

FIGS. 5 and 6 show block diagrams of devices that support coordinated multi-user dynamic SBFD for UWB in accordance with one or more aspects of the present disclosure.

FIG. 7 shows a block diagram of a communications manager that supports coordinated multi-user dynamic SBFD for UWB in accordance with one or more aspects of the present disclosure.

FIG. 8 shows a diagram of a system including a device that supports coordinated multi-user dynamic SBFD for UWB in accordance with one or more aspects of the present disclosure.

FIGS. 9 and 10 show block diagrams of devices that support coordinated multi-user dynamic SBFD for UWB in accordance with one or more aspects of the present disclosure.

FIG. 11 shows a block diagram of a communications manager that supports coordinated multi-user dynamic SBFD for UWB in accordance with one or more aspects of the present disclosure.

FIG. 12 shows a diagram of a system including a device that supports coordinated multi-user dynamic SBFD for UWB in accordance with one or more aspects of the present disclosure.

FIGS. 13 and 14 show flowcharts illustrating methods that support coordinated multi-user dynamic SBFD for UWB in accordance with one or more aspects of the present disclosure.

### DETAILED DESCRIPTION

In wireless communications systems, a user equipment (UE) may communicate using sub-band full duplex (SBFD), where within a same time resource (e.g., a slot), a first set of frequency resources (e.g., a first sub-band) are used for transmitting signals (e.g., uplink) and a second set of frequency resources (e.g., a second sub-band) are used for receiving signals (e.g., downlink). To avoid excessive transmitter-receiver interference (which may arise when the UE is simultaneously transmitting and receiving), the first sub-band and the second sub-band may be spaced apart from each other with a frequency gap. The frequency gap that arises due to the sub-band spacing may results in poor or inefficient spectrum use. In addition, SBFD may be used over an ultra wide band (UWB) bandwidth, which is an unlicensed spectrum. In some cases, a UWB bandwidth may have assigned sub-bands. However, the assigned sub-bands may not be optimized for SBFD capabilities of communicating devices (e.g., the separation gap between sub-bands may not be ideal or compatible for a given UE or wireless communication device's capabilities). In some examples, SBFD over UWB may be used for communications between a UE and an extended reality (XR) device.

The inefficiencies in spectrum use that arise from SBFD may be mitigated if the separation gaps between SBFD sub-bands for a pair of devices are used for SBFD communications by another pair of devices. In other words, multiplexing SBFD communications between multiple pairs of devices may more efficiently utilize the spectrum. Additionally, dynamically providing SBFD configurations to pairs of devices may ensure that a UWB bandwidth is efficiently used. Goals of efficiently utilizing the spectrum may be accomplished by using one of two coordination procedures.

In a network implemented coordination procedure, a network entity may coordinate SBFD of the UWB for communication between a UE and a wireless communication device (e.g., an XR device). The network entity may receive an SBFD capability of the UE or a capability of the wireless communication device. When the network entity receives a request for communication resources for SBFD communications between the UE and the wireless communication device, the network entity may signal an SBFD configuration to the UE and wireless communication device, where the configuration indicates the SBFD sub-bands for communications between the UE/wireless communications device pair. The allocation of the sub-bands to the UE/wireless communication device pair may be such that the network entity is also able to allocate intervening sub-bands to another UE/wireless communication device pair for additional SBFD communication.

In another coordination procedure, which may be referred to as a distributed coordination option, the coordination may be performed by a UE. The network entity may either assign a UE as a Master UE (e.g., controller UE), or a UE may autonomously announce that it is a Master UE. The Master UE may receive the SBFD capability reports of other UEs and allocate the spectrum accordingly (upon receipt of allocation requests from the other UEs).

Aspects of the disclosure are initially described in the context of wireless communications systems. Aspects of the disclosure are further illustrated by and described with reference to apparatus diagrams, system diagrams, and flowcharts that relate to coordinated multi-user dynamic SBFD for UWB.

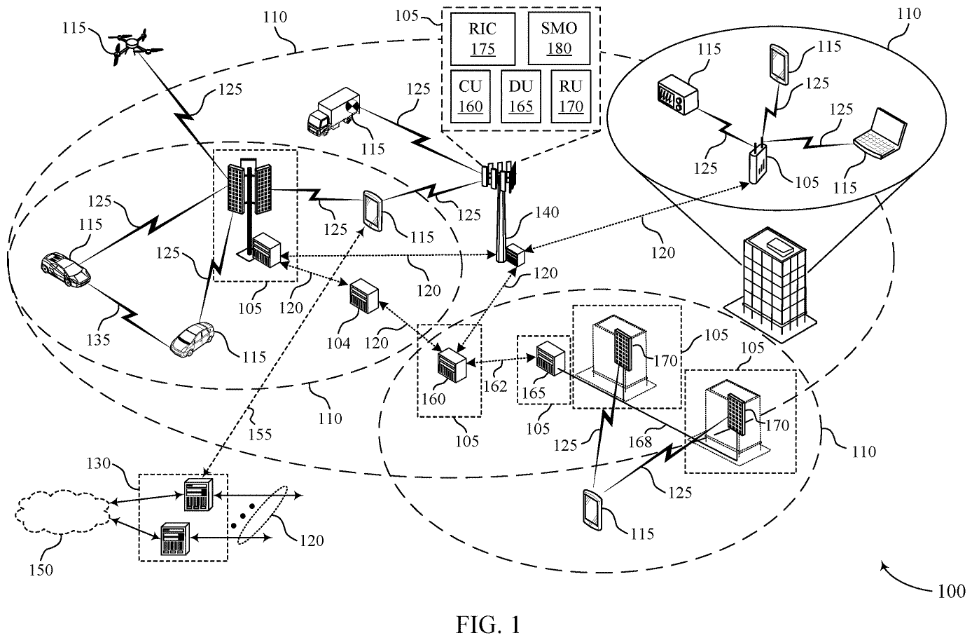

FIG. 1 shows an example of a wireless communications system 100 that supports coordinated multi-user dynamic SBFD for UWB in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support coordinated multi-user dynamic SBFD for UWB for UWB as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system may implement UWB wireless communications. Due to the large bandwidth of UWB (e.g., 3.1 GHz to 10.6 GHz, where each radio channel may have a bandwidth of more than 500 MHz depending upon a center frequency), UWB may allow for accurate and robust positioning. UWB may facilitate high throughout and low power short-range links for personal area network (PAN) or body area network (BAN) applications (e.g., augmented reality (AR) or XR applications, uncompressed video or audio streaming for a wireless personal computer environment, or compressed video or audio streaming for a wireless personal computer environment). Although UWB is an unlicensed spectrum, spectrum coordination between neighboring UWB devices may be performed, for example, when using a 6G network.

In some examples, a solution for lower latency (offering almost zero latency) may include full duplexing (transmit and receiving simultaneously on the same frequencies). However, full duplexing communications may result in coupling between the transmitter and receiver (e.g., between a network entity 105 and a UE 115 or between multiple UEs 115), where the transmitted signal is transmitted with high power and results in large transmission and reception interference floors, as well as saturation of the RF chain that prevents proper reception.

In SBFD, latency problems and interference issues may be reduced. The transmission and reception signals may be communicated on different frequencies that may be far enough that the attenuation or isolation from the transmitter to the receiver is sufficient. The transmission and reception frequency separation may be achieved by a reception path in the device and the device may include a bandpass filter that removes transmission leakage. In some examples, the bandpass filtering may include multiple stages (e.g., multiple stages of filtering) in the reception path. UWB regulations may regulate and cause low transmission power, facilitating the transmission and reception isolation with relatively lower transmission leakage removal or rejection regulations.

However, a single user SBFD may result in inefficient UWB spectrum allocation, for example, due to the unused spectrum separation gap between the transmission frequency band and the reception frequency band. Accordingly, a coordinated or synchronized multi-user scenario may remove the inefficiencies by allocating the unused spectrum for other transmissions and receptions (e.g., a frequency gap between one UE or group of UEs be used by another UE or another group of UEs for transmission and reception.

UWB regulations (e.g., Federal Communications Commission (FCC) or equivalent isotropic radiated power (EIRP) regulations) may partition the UWB spectrum into carriers of 500 MHz each. The UWB regulations may facilitate FD (or its derivative) mode of operation.

UEs 115 may communicate using SBFD, where a first set of frequency resources (e.g., a first sub-band) are used for transmitting signals (e.g., uplink) and a second set of frequency resources (e.g., a second sub-band) are used for receiving signals (e.g., downlink). To avoid excessive transmitter-receiver interference, the first sub-band and the second sub-band are spaced apart from each other with a frequency gap. The frequency gap may result in poor or inefficient spectrum use. The UEs 115 may communicate over UWB.

The inefficiencies in spectrum use that arise from SBFD may be mitigated if the separation gaps between SBFD sub-bands for a pair of devices are used for SBFD communications by another pair of devices. Additionally, dynamically providing SBFD configurations to pairs of devices may ensure that a UWB is efficiently used. Goals of efficiently utilizing the spectrum may be accomplished by using one of two coordination procedures.

In a network implemented coordination procedure, a network entity 105 may coordinate SBFD of the UWB for communication between a UE 115 and a wireless communication device (e.g., an XR device), as well as between other pairs of UEs 115 and wireless communication devices. The network entity 105 may receive an SBFD capability of the UE 115 or a capability of the wireless communication device. Thus, when the network entity 105 subsequently receives a request for communication resources for SBFD communications between the UE 115 and the wireless communication device, the network entity 105 may signal an SBFD configuration to the UE 115 and wireless communication device, where the configuration includes the SBFD sub-bands. The allocation of the sub-bands to the UE 115 and wireless communication device pair may such that the network entity 105 is also able to allocate intervening sub-bands to another UE 115 and wireless communication device pair for additional SBFD communication. In another coordination procedure, the coordination may be performed by a UE 115. The network entity 105 may either assign a UE 115 as a Master UE 115 (e.g., controller UE), or a UE 115 may autonomously announce that it is a Master UE 115. The Master UE 115 may receive the SBFD capability reports of other UEs 115 and allocate the spectrum accordingly (upon receipt of allocation requests from the other UEs 115).

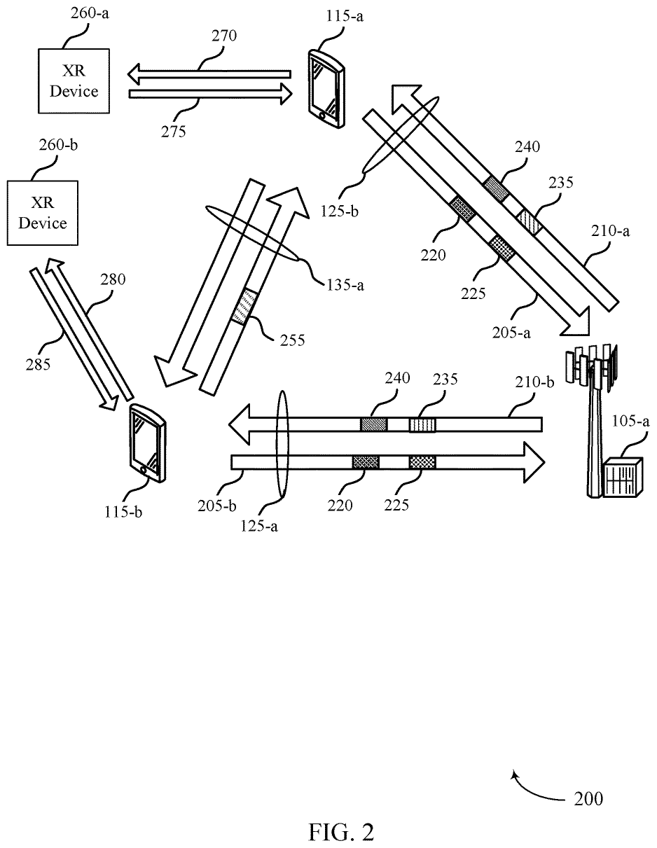

FIG. 2 shows an example of a wireless communications system 200 that supports coordinated multi-user dynamic SBFD for UWB in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b.

The UE 115-a may communicate with the UE 115-b using a communication link 135-a, which may be an example of a communication link 135 as described herein. For example, the communication link 135-a may be a sidelink communication link and may support bidirectional communications between the UE 115-a and the UE 115-b.

In some aspects, the wireless communications system 200 may support coordination among multiple UEs 115-wireless communication device pairs involving UEs 115 and other wireless communications devices, such as XR devices 260. The network entity 105 may receive, from the first UE 115-a and the second UE 115-b, a message 220 indicating a capability of the UE 115 to support SBFD with another device, such as a first XR device 260-a and a second XR device 260-b. The network entity 105 may receive, from the first UE 115-a or the second UE 115-b, a request 225 for resources for the SBFD with the other wireless communication device or the XR devices 260.

The network entity 105 may transmit control signaling 235 to the UEs 115 based on the capabilities (e.g., from the message 220 indicating the capability) and the requests 225. For example, the network entity 105 may transmit the control signaling 235 to the first UE 115-a. The control signaling 235 may indicate a first frequency band 270 for signaling from the first UE 115-a to the second wireless communications device, such as the XR device 260-a, and a second frequency band 275 for signaling from the second wireless communications device to the first UE 115-a. The first frequency band 270 and the second frequency band 275 may be separated in the frequency domain by a third frequency band 280, which may be allocated by the network entity 105, for SBFD between the second UE 115-b and a second wireless communication device, such as a second XR device 260-b. In some examples, the third frequency band 280 may be used for signaling from second UE 115-b to the second XR device 260-b, and a fourth frequency band 285 may be used for signaling from the second XR device 260-b to the second UE 115-b.

In some examples, the network entity 105 may transmit a beacon 240 to the first UE 115-a or the second UE 11-5 indicating that the first UE 115-a or the second UE 115-b is a Master UE 115, which may perform the coordination. In some examples, a first wireless communication device (rather than the network entity 105) may perform the coordination. For example, a first wireless communication device may receive an indication, from a network entity 105, that the first wireless communication device (e.g., the first UE 115-a) is a Master UE 115 and subsequently transmits a beacon to other UEs 115 (e.g., the second UE 115-b) indicating that the first UE 115-a is the Master UE 115. In some cases, the first UE 115-a may be a Master UE 115 based on a failure to detect a beacon from another UE 115.

The coordinating devices, such as the network entity 105 or the first wireless communication device (e.g., Master UE 115), may transmit control signaling 235 to the first UE 115-a indicating the first frequency band 270 for signaling from the first UE 115-a to the second wireless communication device and the second frequency band 275 for signaling from the second wireless communication device to the first UE 115-a (e.g., first UE-wireless communication device pair), and control signaling 235 indicating the third frequency band 280 for signaling from the second UE 115-b to the second wireless communication device and the fourth frequency band 285 for signaling from the second wireless communication device to the second UE 115-b (e.g., second UE-wireless communication device pair).

The coordinating device, such as the first wireless communication device, may receive an indication of a supported threshold frequency gap for transmission and reception from the first UE 115-a, where a frequency separation between the first frequency band and the second frequency band is based on the supported threshold frequency gap. In some examples, the first wireless communication device may receive an indication of a supported threshold frequency gap for transmission and reception from the second UE 115-b, where a frequency separation between the third frequency band 280 and the fourth frequency band 285 is based on the supported threshold frequency gap.

The first wireless communication device may receive, from the first UE 115, an indication of a second capability of the second wireless communications device to support SBFD communication, where the control signaling is further based at least in part on the second capability. In some examples, where the first wireless communication device is the Master UE 115, for example, the first UE 115-a, the capability of the UE 115-b may be indicated by a message 255, and the request 225 for resources, and the control signaling 235 may be communicated via a licensed sidelink communication link (e.g., communication link 135-a). When the first wireless communications device is a network entity 105, the message 220, the request 225 for resources, and the control signaling 235 may be communicated via a licensed access communication link.

Using the coordinated multi-user dynamic SBFD scheme described herein for UWB may facilitate SBFD scheme employment on UWB for a multi-user scenario, enable SBFD for an ensemble of local low-power and low-cost devices, allow dynamic allocation for the multi-user SBFD. The coordinated multi-user dynamic SBFD for UWB may provide lower latency, such as DC with approximately zero latency, as well as dynamic UWB spectrum allocation.

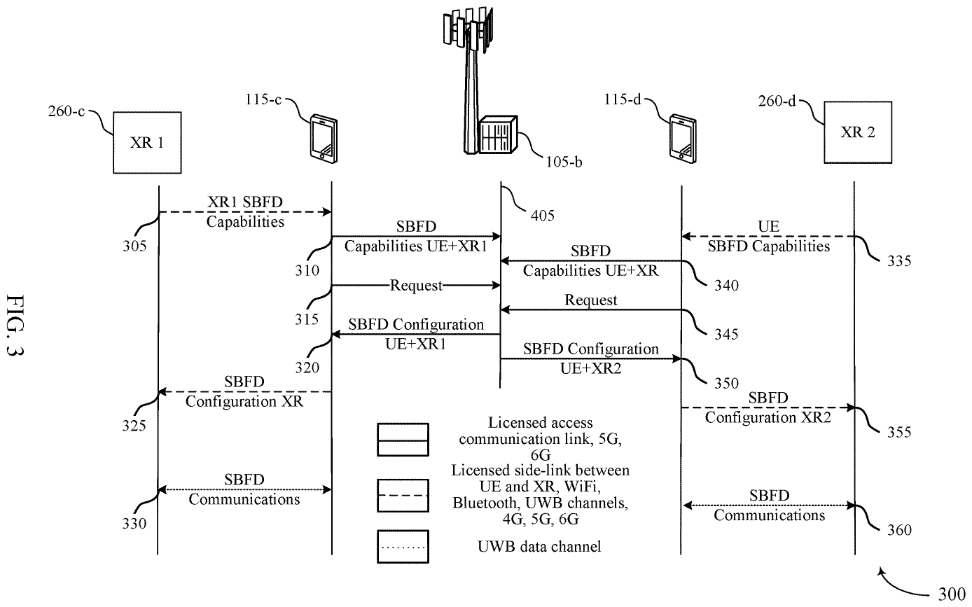

FIG. 3 shows an example of a process flow 300 that supports coordinated multi-user dynamic SBFD for UWB in accordance with one or more aspects of the present disclosure. The process flow 300 may include UE 115-c and UE 115-d, which may be examples of UE 115, as described herein. The process flow 300 may also include a network entity 105-b, which may be an example of network entity 105, as described herein. The process flow 300 may also include XR device 260-c and XR device 260-d, which may be an example of XR device 260, as described herein. In the following description of the process flow 300, the operations between the network entity 105-b and the UEs 115, as well as the operations between the UEs 115 and the XR devices 260, may be transmitted in a different order than the example order shown, or the operations may be performed in different orders or at different times. Some operations may also be omitted from the process flow 300, and other operations may be added to the process flow 300.

In some examples, the network entity 105-c may coordinate the SBFD for multiple UE-XR devices (e.g., centralized coordination). At 305, the XR device 260-c may communicate SBFD capabilities to the UE 115-c. The UE 115-c may also be capable of SBFD and at 310, the UE 115-c may communicate SBFD capabilities of both the UE 115-c and the XR device 260-c to the network entity 105-b. The UE 115-c may also, at 315, transmit a request for communicating with the XR device 260-c in SBFD. At 320, the network entity 105 may provide SBFD configuration for the UE 115-c and the XR device 260-c. For example, the SBFD configuration may indicate the first frequency band for communications from the UE 115-c to the XR device 260-c and the second frequency band for communications from the XR device 260-c to the UE 115-c. The first frequency band and the second frequency band may be separated by a third frequency band or a fourth frequency band that is allocated for SBFD communication between the UE 115-d and the XR device 260-d. Accordingly, the network entity 105-b may receive the SBFD capabilities and request for SBFD communication from the UE 115-d before or approximately the same time as the UE 115-c (e.g., steps 335, 340, 345, 350, 355, and 360).

At 325, the UE 115-c may transmit the SBFD configuration for the UE 115-c and the XR device 260-c that was received from the network entity 105-b, to the XR device 260-c. At 330, the UE 115-c and the XR device 260-c may communicate in SBFD over the first and second frequency bands. Similar operations may be performed and apply to the UE 115-d and the XR device 260-d.

For example, at 335, the XR device 260-d may communicate SBFD capabilities to the UE 115-d. The UE 115-d may also be capable of SBFD and at 340, the UE 115-d may communicate SBFD capabilities of both the UE 115-d and the XR device 260-d to the network entity 105-b. The UE 115-d may also, at 345, transmit a request to the network entity 105-c for communicating with the XR device 260-d in SBFD. At 350, the network entity 105 may provide SBFD configuration for the UE 115-d and the XR device 260-d. For example, the SBFD configuration may indicate the third frequency band for communications from the UE 115-d to the XR device 260-d and the fourth frequency band for communications from the XR device 260-d to the UE 115-d. The third frequency band and the fourth frequency band may be separated by the first frequency band or the second frequency band that is allocated for SBFD communication between the UE 115-c and the XR device 260-c. Accordingly, the network entity 105-b may coordinate SBFD for multiple UE-wireless communication device pairs over the UWB to reduce unused bandwidth of the UWB. The coordination may be simultaneous for the multiple UE-wireless communication device pairs, as well as dynamic so that the spectrum allocation is updated accordingly the quantity of UE-wireless communication device pairs and respective used or unused UWB frequencies.

The SBFD configurations provided by the network entity 105 may facilitate SBFD communications, as well as uplink and downlink frequency ranges where the leakage between a UEs 115 transmission and reception may be small with little impact on the simultaneous transmission and reception.

The SBFD configuration from the network entity 105 may be based on the corresponding UE/XR capabilities and the UE/XR requests (per UE-XR pair). The UE/XR capabilities may include the capability to support SBFD, and the SBFD supported configurations may include filter sets, sub-bands combinations, and transmission-reception gaps. The UE/XR requests may include the TX/RX bandwidth where each UE 115 may have different uplink and downlink traffic volume for transmission and reception. The uplink and downlink sub-band combination may be prioritized based on local spectral measurements and channel estimations. In some examples, communication link between UEs 115 and network entity 105 may use 5G or 6G licensed frequencies rather than UWB link. The UWB may be used for UE-XR communications, as discussed herein. In some examples, a Master UE 115 may perform the multi-user coordination.

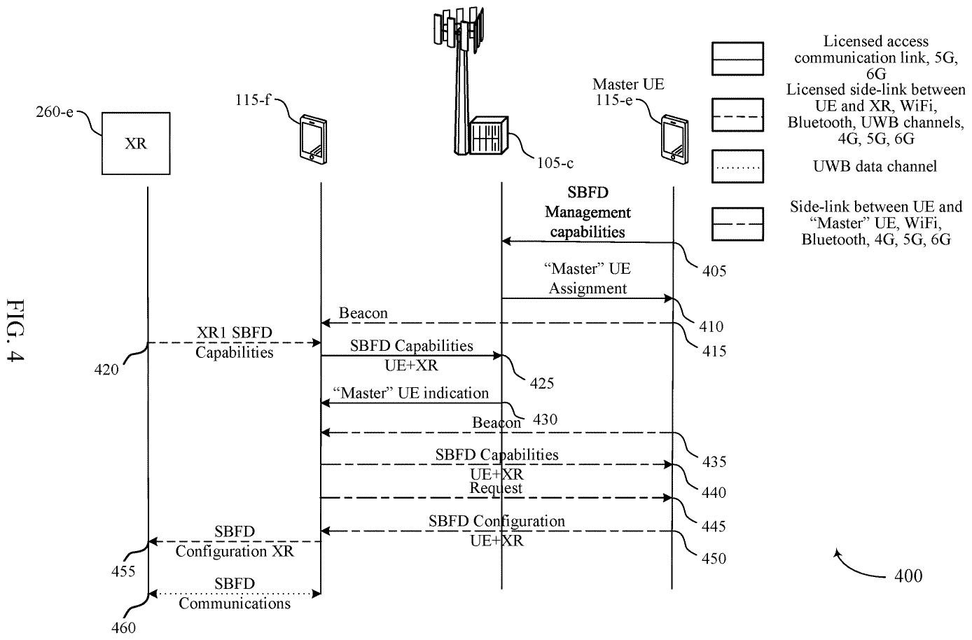

FIG. 4 shows an example of a process flow 400 that supports coordinated multi-user dynamic SBFD for UWB in accordance with one or more aspects of the present disclosure. The process flow 400 may include UE 115-e and UE 115-f, which may be examples of UE 115, as described herein. The process flow 400 may also include a network entity 105-b, which may be an example of network entity 105, as described herein. The process flow 400 may also include XR device 260-e, which may be an example of XR device 260, as described herein. In the following description of the process flow 400, the operations between the network entity 105-b and the UEs 115, as well as the operations between the UE 115 and the XR devices 260, may be transmitted in a different order than the example order shown, or the operations may be performed in different orders or at different times. Some operations may also be omitted from the process flow 400, and other operations may be added to the process flow 400.

At 405, the UE 115-e transmits an indication of SBFD management capabilities to the network entity 105-c. At 410, the network entity 105-c assigns the UE 115-e as the “Master” UE 115 that will provide coordination for multi-user SBFD. At 415, the UE 115-e, which is the Master UE 115, transmits a beacon to other UEs 115, including the UE 115-f that UE 115-e is the Master UE.

At 420, the XR device 260-e transmits SBFD capabilities of the XR device 260-e to the UE 115-f. At 425, the UE 115-f transmits an indication of SBFD capabilities of the UE 115-f and the XR device 260-e to the network entity 105-c. At 430, the network entity 105-c transmits an indication of “Master” UE to the UE 115-f to indicate that the UE 115-e is the Master UE 115 that performs coordination and allocation of the UWB.

However, in some examples, the Master assignment may change. For example, the beacon from the Master UE 115-e is provided prior to the UE 115-f transmits the indication of the SBFD capabilities to the network entity 105-c. In some examples, the UE 115-e may not have received an indication of a Master UE (e.g., since the UE 115-f had not yet received the SBFD capabilities from the XR device 260-e to perform SBFD with the XR device 260-e). The SBFD coordination is dynamic and thus, as UEs 115 are added or removed from the SBFD coordination scheme, the Master UE 115 may change, as well as frequencies to be allocated to SBFD for UE-XR pairs. In examples, if the UE 115-f does not receive a master indication, the UE 115-f may become the Master UE 115 (e.g., self-assignment) and transmit the beacon to other UEs 115 accordingly.

In some examples, where the UE 115-e is the Master UE 115, at 435, the UE 115-e may transmit the beacon again to indicate that the UE 115-e is the Master UE 115. Accordingly, at 440, the UE 115-f transmits the indication of the SBFD capabilities of the UE 115-f and the XR device 260-e to the Master UE 115-e.

At 445, the UE 115-f may transmit the request for SBFD between the UE 115-f and the XR device 260-e to the Master UE 115-e (rather than the network entity 105-c). At 450, the Master UE 115-e transmits the SBFD configuration for the UE 115-f and the XR device 260-e to the UE 115-f. At 455, the UE 115-f transmits the SBFD configuration for the UE-XR pair to the XR device 260-e. At 460, the UE 115-e and the XR device 260-e may communicate in SBFD according to the SBFD configuration.

In the “Master” UE 115 coordination (e.g., non-centralized coordination), the network entity 105-c may assign the “Master” UE (per local small size spot according to UWB link coverage), the “Master” UE assignment may be performed arbitrarily, where a UE 115 self-assigns the UE 115 as the Master. The Master UE 115 may send beacons to indicate presence and the non-Master UEs 115 may send SBFD related requests to the Master UE 115. The Master UE may provide SBFD configurations for the UEs 115 that send the request for UE-XR SBFD.

In the example of arbitrary UE self-assignment, if the UE 115 cannot communicate with the network entity 105, then the UE 115 may listen for beacons of possible Master UEs 115. If a Master UE has not been assigned or cannot be detected by the UE 115 (after a predetermined threshold monitoring time), then the UE 115 may assume or self-assign as the “Master” UE 115. The Master UE 115 may start sending beacons (without a request from another UE 115 or network entity 105) to support the coordination procedures. The techniques discussed herein for FIGS. 2-4 may also apply to a UE 115 or a user device that is paired with multiple XR devices 260 simultaneously. The XR device 260 may indicate SBFD capabilities to UE via side-link and the UE 115 may indicate the combined configuration to of the UE 115 and the XR device 260 to the network entity 105 or the Master UE 115.

The UE-XR side-link control communications (e.g., for the communications at 420 and/or 455 of FIG. 4 or the communications at 305, 325, 335, and/or 355 of FIG. 3)) may include Wi-Fi, Bluetooth, 4G, 5G, or 6G side-link, a UWB default or known discovery channel.

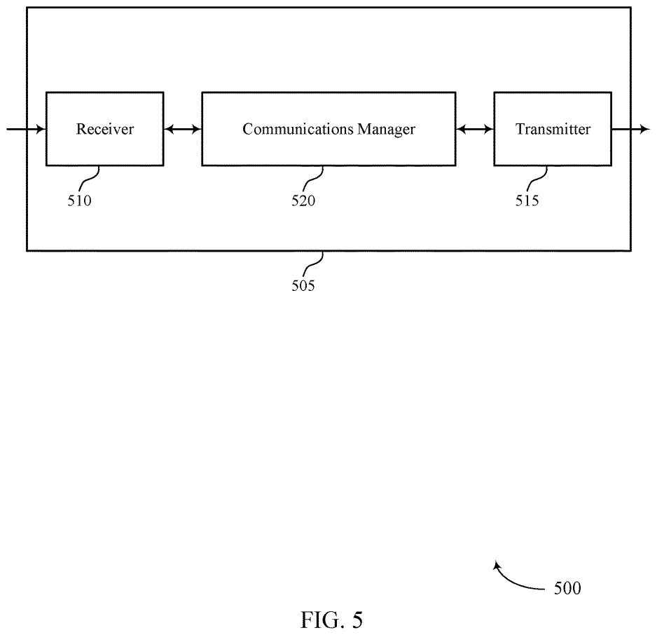

FIG. 5 shows a block diagram 500 of a device 505 that supports coordinated multi-user dynamic SBFD for UWB in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of coordinated multi-user dynamic SBFD for UWB as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first wireless communications device in accordance with examples as disclosed herein. For example, the communications manager 520 is capable of, configured to, or operable to support a means for receiving, from a first UE, an indication of a capability of the first UE to support SBFD communication with a second wireless communications device. The communications manager 520 is capable of, configured to, or operable to support a means for receiving, from the first UE, a request for resources for the SBFD communication with the second wireless communications device. The communications manager 520 is capable of, configured to, or operable to support a means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for dynamic and simultaneous coordination of multiple UEs 115 performing SBFD using UWB, where the multi-user coordination of the UEs 115 reduces unused frequencies of the UWB spectrum.

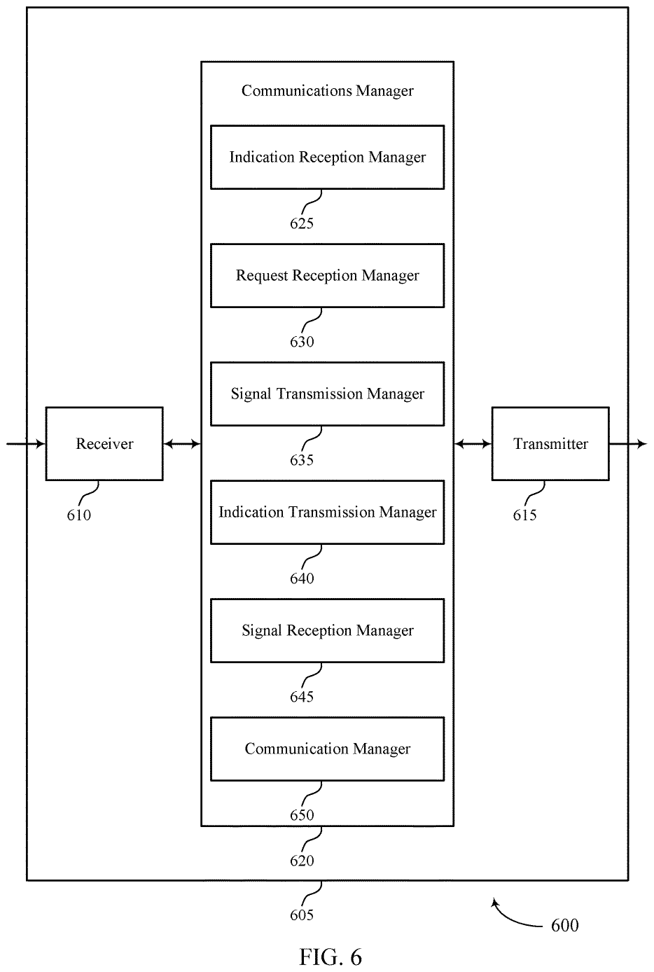

FIG. 6 shows a block diagram 600 of a device 605 that supports coordinated multi-user dynamic SBFD for UWB in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of coordinated multi-user dynamic SBFD for UWB as described herein. For example, the communications manager 620 may include an indication reception manager 625, a request reception manager 630, a signal transmission manager 635, an indication transmission manager 640, a signal reception manager 645, a communication manager 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless communications device in accordance with examples as disclosed herein. The indication reception manager 625 is capable of, configured to, or operable to support a means for receiving, from a first UE, an indication of a capability of the first UE to support SBFD communication with a second wireless communications device. The request reception manager 630 is capable of, configured to, or operable to support a means for receiving, from the first UE, a request for resources for the SBFD communication with the second wireless communications device. The signal transmission manager 635 is capable of, configured to, or operable to support a means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

Additionally, or alternatively, the communications manager 620 may support wireless communication at a second wireless communications device in accordance with examples as disclosed herein. The indication transmission manager 640 is capable of, configured to, or operable to support a means for transmitting, to a UE, an indication of a capability of the second wireless communications device to support SBFD communication with the UE. The signal reception manager 645 is capable of, configured to, or operable to support a means for receiving, from the UE based on the capability of the second wireless communications device, control signaling indicating a first frequency band for signaling from the UE to the second wireless communications device and a second frequency band for signaling from the second wireless communications device to the UE. The communication manager 650 is capable of, configured to, or operable to support a means for communicating with the UE via the first frequency band and the second frequency band.

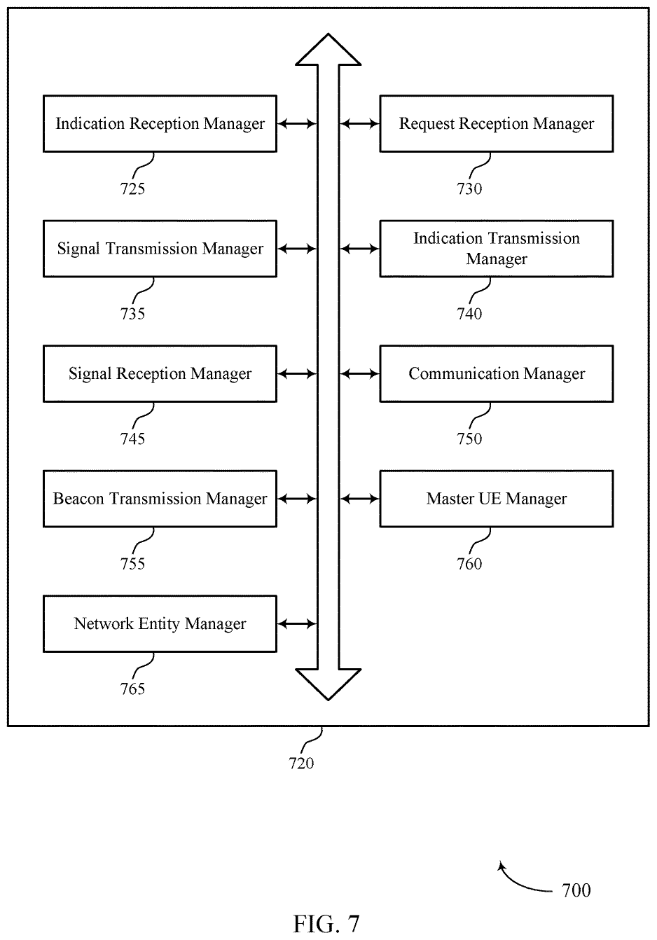

FIG. 7 shows a block diagram 700 of a communications manager 720 that supports coordinated multi-user dynamic SBFD for UWB in accordance with one or more aspects of the present disclosure. The communications manager 720 may be an example of aspects of a communications manager 520, a communications manager 620, or both, as described herein. The communications manager 720, or various components thereof, may be an example of means for performing various aspects of coordinated multi-user dynamic SBFD for UWB as described herein. For example, the communications manager 720 may include an indication reception manager 725, a request reception manager 730, a signal transmission manager 735, an indication transmission manager 740, a signal reception manager 745, a communication manager 750, a beacon transmission manager 755, a Master UE manager 760, a network entity manager 765, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication at a first wireless communications device in accordance with examples as disclosed herein. The indication reception manager 725 is capable of, configured to, or operable to support a means for receiving, from a first UE, an indication of a capability of the first UE to support SBFD communication with a second wireless communications device. The request reception manager 730 is capable of, configured to, or operable to support a means for receiving, from the first UE, a request for resources for the SBFD communication with the second wireless communications device. The signal transmission manager 735 is capable of, configured to, or operable to support a means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

In some examples, the indication reception manager 725 is capable of, configured to, or operable to support a means for receiving an indication, from a network entity, that the first wireless communications device is a Master UE. In some examples, the beacon transmission manager 755 is capable of, configured to, or operable to support a means for transmitting, in response to receiving the indication that the first wireless communications device is the Master UE, a beacon indicating that the first wireless communications device is the Master UE, where the indication of the capability is received at the first wireless communications device in response to the beacon.

In some examples, the Master UE manager 760 is capable of, configured to, or operable to support a means for determining that the first wireless communications device is a Master UE based on a failure to detect a beacon from another UE. In some examples, the beacon transmission manager 755 is capable of, configured to, or operable to support a means for transmitting, in response to determining that the first wireless communications device is the Master UE, the beacon indicating that the first wireless communications device is the Master UE, where the indication of the capability is received at the first wireless communications device in response to the beacon.

In some examples, the indication reception manager 725 is capable of, configured to, or operable to support a means for receiving, from the first UE, an indication of a second capability of the second wireless communications device to support SBFD communication, where the control signaling is further based on the second capability of the second wireless communications device.

In some examples, to support receiving the indication of the capability, the indication reception manager 725 is capable of, configured to, or operable to support a means for receiving an indication of a supported threshold frequency gap (e.g., minimum frequency gap) for transmission and reception, where a frequency separation between the first frequency band and the second frequency band is based on the supported threshold frequency gap.

In some examples, the first wireless communications device is a Master UE. In some examples, the indication of the capability, the request for resources, and the control signaling are communicated via a licensed sidelink communication link.

In some examples, the first wireless communications device is a network entity. In some examples, the indication of the capability, the request for resources, and the control signaling are communicated via a licensed access communication link.

In some examples, the indication reception manager 725 is capable of, configured to, or operable to support a means for receiving, from the second UE, a second indication of a second capability of the second UE to support the SBFD communication with the third wireless communications device. In some examples, the request reception manager 730 is capable of, configured to, or operable to support a means for receiving, from the second UE, a second request for resources for communication with the third wireless communications device. In some examples, the signal transmission manager 735 is capable of, configured to, or operable to support a means for transmitting, to the second UE based on the second capability of the second UE and in response to the request, control signaling indicating the third frequency band for signaling from the second UE to the third wireless communications device and a fourth frequency band for signaling from the third wireless communications device to the second UE.

In some examples, the second wireless communications device includes an extended reality entity.

In some examples, to support receiving the request, the indication reception manager 725 is capable of, configured to, or operable to support a means for receiving an indication of a relative priority of a combination of the first frequency band and the second frequency band with respect to other combinations of frequency bands, where the first frequency band and the second frequency band are based on the relative priority.

In some examples, to support receiving the request, the indication reception manager 725 is capable of, configured to, or operable to support a means for receiving an indication of a first traffic condition associated with signaling from the first UE to the second wireless communications device and a second traffic condition associated with signaling from the second wireless communications device to the first UE, where the first frequency band and the second frequency band are based on the first traffic condition and the second traffic condition.

Additionally, or alternatively, the communications manager 720 may support wireless communication at a second wireless communications device in accordance with examples as disclosed herein. The indication transmission manager 740 is capable of, configured to, or operable to support a means for transmitting, to a UE, an indication of a capability of the second wireless communications device to support SBFD communication with the UE. The signal reception manager 745 is capable of, configured to, or operable to support a means for receiving, from the UE based on the capability of the second wireless communications device, control signaling indicating a first frequency band for signaling from the UE to the second wireless communications device and a second frequency band for signaling from the second wireless communications device to the UE. The communication manager 750 is capable of, configured to, or operable to support a means for communicating with the UE via the first frequency band and the second frequency band.

In some examples, to support transmitting the indication of the capability, the indication transmission manager 740 is capable of, configured to, or operable to support a means for transmitting, to the UE, an indication of a supported threshold frequency gap for transmission and reception, where a frequency separation between the first frequency band and the second frequency band are based on the supported threshold frequency gap.

In some examples, the indication of the capability and the control signaling are via an unlicensed sidelink communication link and the SBFD communication via the first frequency band and the second frequency band is via an ultra wide band communication link.

In some examples, the second wireless communications device includes an extended reality device.

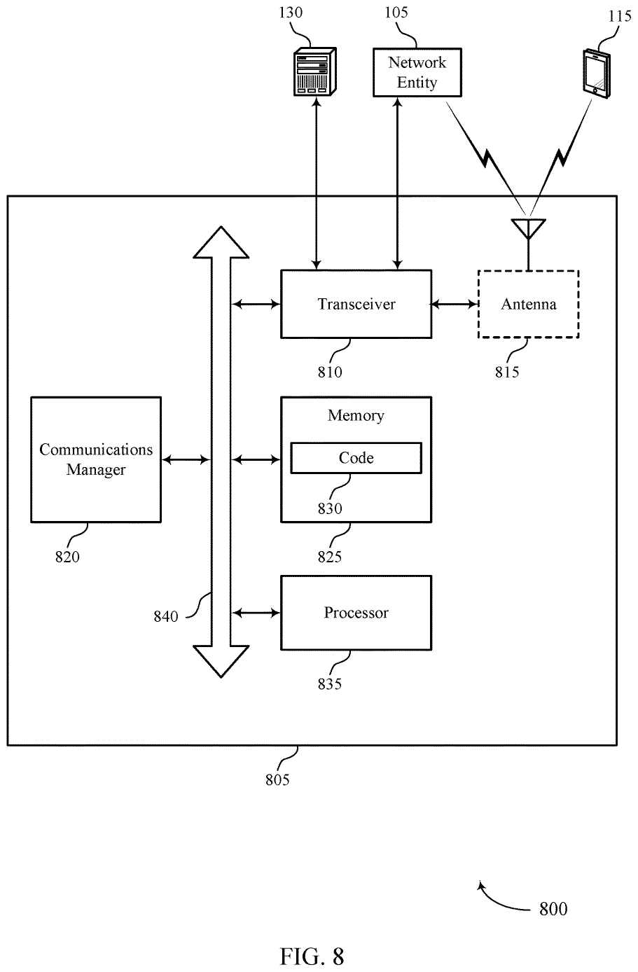

FIG. 8 shows a diagram of a system 800 including a device 805 that supports coordinated multi-user dynamic SBFD for UWB in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting coordinated multi-user dynamic SBFD for UWB). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communication at a first wireless communications device in accordance with examples as disclosed herein. For example, the communications manager 820 is capable of, configured to, or operable to support a means for receiving, from a first UE, an indication of a capability of the first UE to support SBFD communication with a second wireless communications device. The communications manager 820 is capable of, configured to, or operable to support a means for receiving, from the first UE, a request for resources for the SBFD communication with the second wireless communications device. The communications manager 820 is capable of, configured to, or operable to support a means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

Additionally, or alternatively, the communications manager 820 may support wireless communication at a second wireless communications device in accordance with examples as disclosed herein. For example, the communications manager 820 is capable of, configured to, or operable to support a means for transmitting, to a UE, an indication of a capability of the second wireless communications device to support SBFD communication with the UE. The communications manager 820 is capable of, configured to, or operable to support a means for receiving, from the UE based on the capability of the second wireless communications device, control signaling indicating a first frequency band for signaling from the UE to the second wireless communications device and a second frequency band for signaling from the second wireless communications device to the UE. The communications manager 820 is capable of, configured to, or operable to support a means for communicating with the UE via the first frequency band and the second frequency band.

By including or configuring the communications manager 820 in accordance with examples as described herein, the device 805 may support techniques for dynamic and simultaneous coordination of multiple UEs 115 performing SBFD in a UWB, where the multi-user coordination of the UEs 115 reduces unused frequencies of the UWB spectrum.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, the processor 835, the memory 825, the code 830, or any combination thereof. For example, the code 830 may include instructions executable by the processor 835 to cause the device 805 to perform various aspects of coordinated multi-user dynamic SBFD for UWB as described herein, or the processor 835 and the memory 825 may be otherwise configured to perform or support such operations.

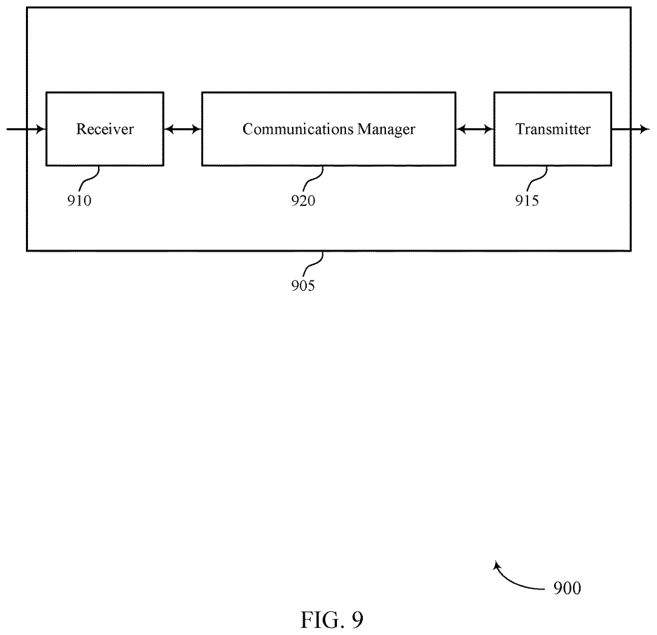

FIG. 9 shows a block diagram 900 of a device 905 that supports coordinated multi-user dynamic SBFD for UWB in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to coordinated multi-user dynamic SBFD for UWB). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to coordinated multi-user dynamic SBFD for UWB). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of coordinated multi-user dynamic SBFD for UWB as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first wireless communications device in accordance with examples as disclosed herein. For example, the communications manager 920 is capable of, configured to, or operable to support a means for receiving, from a first UE, an indication of a capability of the first UE to support SBFD communication with a second wireless communications device. The communications manager 920 is capable of, configured to, or operable to support a means for receiving, from the first UE, a request for resources for the SBFD communication with the second wireless communications device. The communications manager 920 is capable of, configured to, or operable to support a means for transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device.

Additionally, or alternatively, the communications manager 920 may support wireless communications at a UE in accordance with examples as disclosed herein. For example, the communications manager 920 is capable of, configured to, or operable to support a means for transmitting, to a first wireless communications device, an indication of a capability of the UE to support SBFD communication with a second wireless communications device. The communications manager 920 is capable of, configured to, or operable to support a means for transmitting, to the first wireless communications device, a request for resources for the SBFD communication with the second wireless communications device. The communications manager 920 is capable of, configured to, or operable to support a means for receiving, from the first wireless communications device based on the capability of the UE and in response to the request, control signaling indicating a first frequency band for signaling from the UE to the second wireless communications device and a second frequency band for signaling from the second wireless communications device to the UE. The communications manager 920 is capable of, configured to, or operable to support a means for communicating with the second wireless communications device via the first frequency band and the second frequency band.

Additionally, or alternatively, the communications manager 920 may support wireless communication at a second wireless communications device in accordance with examples as disclosed herein. For example, the communications manager 920 is capable of, configured to, or operable to support a means for transmitting, to a UE, an indication of a capability of the second wireless communications device to support SBFD communication with the UE. The communications manager 920 is capable of, configured to, or operable to support a means for receiving, from the UE based on the capability of the second wireless communications device, control signaling indicating a first frequency band for signaling from the UE to the second wireless communications device and a second frequency band for signaling from the second wireless communications device to the UE. The communications manager 920 is capable of, configured to, or operable to support a means for communicating with the UE via the first frequency band and the second frequency band.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for dynamic and simultaneous coordination of multiple UEs 115 performing SBFD using UWB, where the multi-user coordination of the UEs 115 reduces unused frequencies of the UWB spectrum.

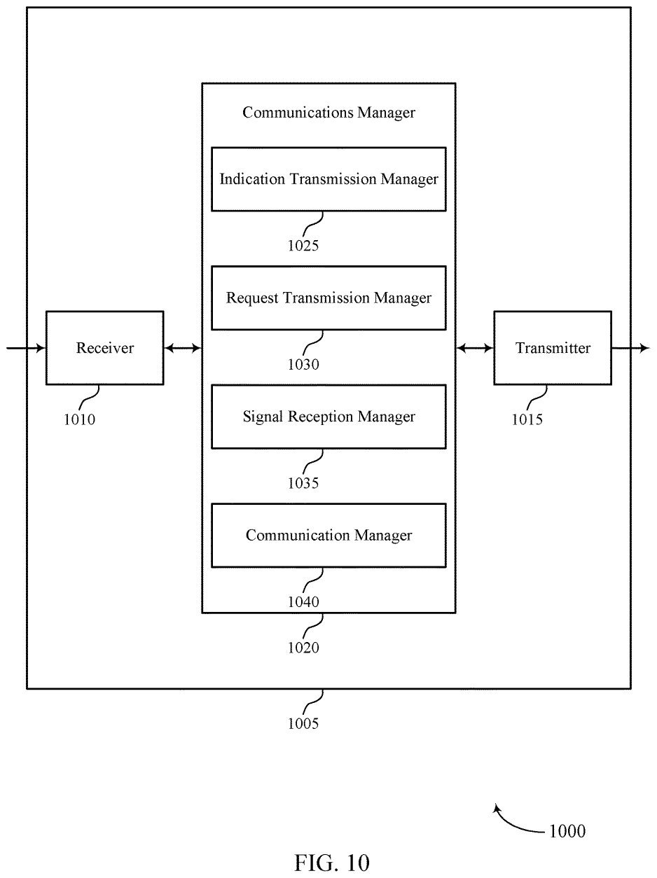

FIG. 10 shows a block diagram 1000 of a device 1005 that supports coordinated multi-user dynamic SBFD for UWB in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to coordinated multi-user dynamic SBFD for UWB). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to coordinated multi-user dynamic SBFD for UWB). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of coordinated multi-user dynamic SBFD for UWB as described herein. For example, the communications manager 1020 may include an indication transmission manager 1025, a request transmission manager 1030, a signal reception manager 1035, a communication manager 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The indication transmission manager 1025 is capable of, configured to, or operable to support a means for transmitting, to a first wireless communications device, an indication of a capability of the UE to support SBFD communication with a second wireless communications device. The request transmission manager 1030 is capable of, configured to, or operable to support a means for transmitting, to the first wireless communications device, a request for resources for the SBFD communication with the second wireless communications device. The signal reception manager 1035 is capable of, configured to, or operable to support a means for receiving, from the first wireless communications device based on the capability of the UE and in response to the request, control signaling indicating a first frequency band for signaling from the UE to the second wireless communications device and a second frequency band for signaling from the second wireless communications device to the UE. The communication manager 1040 is capable of, configured to, or operable to support a means for communicating with the second wireless communications device via the first frequency band and the second frequency band.

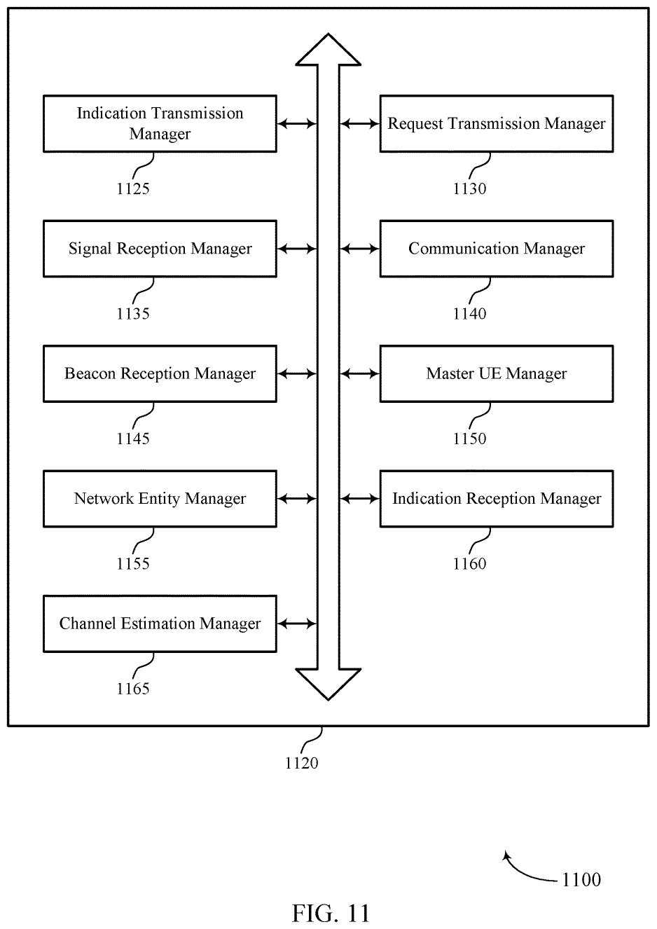

FIG. 11 shows a block diagram 1100 of a communications manager 1120 that supports coordinated multi-user dynamic SBFD for UWB in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of coordinated multi-user dynamic SBFD for UWB as described herein. For example, the communications manager 1120 may include an indication transmission manager 1125, a request transmission manager 1130, a signal reception manager 1135, a communication manager 1140, a beacon reception manager 1145, a Master UE manager 1150, a network entity manager 1155, an indication reception manager 1160, a channel estimation manager 1165, or any combination thereof. Each of these components may communicate, directly or indirectly, with one another (e.g., via one or more buses).

The communications manager 1120 may support wireless communications at a UE in accordance with examples as disclosed herein. The indication transmission manager 1125 is capable of, configured to, or operable to support a means for transmitting, to a first wireless communications device, an indication of a capability of the UE to support SBFD communication with a second wireless communications device. The request transmission manager 1130 is capable of, configured to, or operable to support a means for transmitting, to the first wireless communications device, a request for resources for the SBFD communication with the second wireless communications device. The signal reception manager 1135 is capable of, configured to, or operable to support a means for receiving, from the first wireless communications device based on the capability of the UE and in response to the request, control signaling indicating a first frequency band for signaling from the UE to the second wireless communications device and a second frequency band for signaling from the second wireless communications device to the UE. The communication manager 1140 is capable of, configured to, or operable to support a means for communicating with the second wireless communications device via the first frequency band and the second frequency band.

In some examples, the beacon reception manager 1145 is capable of, configured to, or operable to support a means for receiving a beacon indicating that the first wireless communications device is a Master UE, where the indication of the capability is transmitted in response to the beacon.

In some examples, the indication transmission manager 1125 is capable of, configured to, or operable to support a means for transmitting, to the first wireless communications device, an indication of a second capability of the second wireless communications device to support SBFD communication, where the control signaling is further based on the second capability of the second wireless communications device.

In some examples, the indication reception manager 1160 is capable of, configured to, or operable to support a means for receiving, from the second wireless communications device, the indication of the second capability.

In some examples, to support transmitting the indication of the capability, the indication transmission manager 1125 is capable of, configured to, or operable to support a means for transmitting an indication of a supported threshold frequency gap for transmission and reception, where a frequency separation between the first frequency band and the second frequency band is based on the supported threshold frequency gap.

In some examples, the first wireless communications device is a Master UE. In some examples, the indication of the capability, the request for resources, and the control signaling are communicated via a licensed sidelink. In some examples, the SBFD communication via the first frequency band and the second frequency band are via an ultra wide band communications link.

In some examples, the first wireless communications device is a network entity. In some examples, the indication of the capability, the request for resources, and the control signaling are communicated via a licensed access link. In some examples, the first wireless communications device is a network entity. In some examples, the SBFD communication via the first frequency band and the second frequency band are via an ultra wide band communications link.

In some examples, to support transmitting the request, the indication transmission manager 1125 is capable of, configured to, or operable to support a means for transmitting an indication of a relative priority of a combination of the first frequency band and the second frequency band with respect to other combinations of frequency bands, where the first frequency band and the second frequency band are based on the relative priority.

In some examples, the channel estimation manager 1165 is capable of, configured to, or operable to support a means for performing a channel estimation procedure on a channel between the UE and the second wireless communications device, where the relative priority is based on the channel estimation procedure.

In some examples, to support transmitting the request, the indication transmission manager 1125 is capable of, configured to, or operable to support a means for transmitting an indication of a first relative traffic condition associated with signaling from the UE to the second wireless communications device and a second relative traffic condition associated with signaling from the second wireless communications device to the UE with respect to other traffic conditions associated with other signaling, where the first frequency band and the second frequency band are based on the first traffic condition and the traffic condition.

In some examples, the second wireless communications device includes an extended reality device.

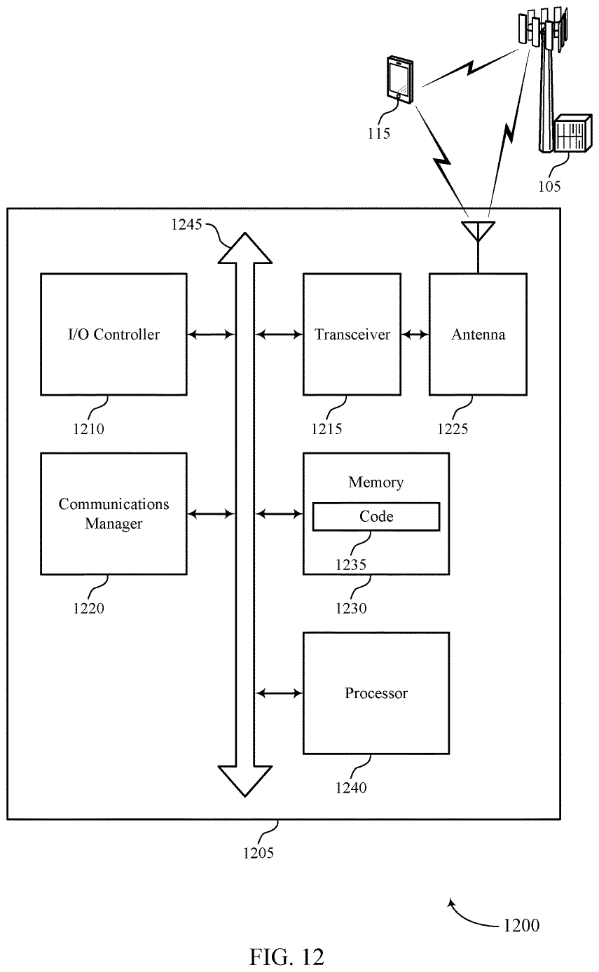

FIG. 12 shows a diagram of a system 1200 including a device 1205 that supports coordinated multi-user dynamic SBFD for UWB in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions.

The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting coordinated multi-user dynamic SBFD for UWB). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 is capable of, configured to, or operable to support a means for transmitting, to a first wireless communications device, an indication of a capability of the UE to support SBFD communication with a second wireless communications device. The communications manager 1220 is capable of, configured to, or operable to support a means for transmitting, to the first wireless communications device, a request for resources for the SBFD communication with the second wireless communications device. The communications manager 1220 is capable of, configured to, or operable to support a means for receiving, from the first wireless communications device based on the capability of the UE and in response to the request, control signaling indicating a first frequency band for signaling from the UE to the second wireless communications device and a second frequency band for signaling from the second wireless communications device to the UE. The communications manager 1220 is capable of, configured to, or operable to support a means for communicating with the second wireless communications device via the first frequency band and the second frequency band.

By including or configuring the communications manager 1220 in accordance with examples as described herein, the device 1205 may support techniques for dynamic and simultaneous coordination of multiple UEs 115 performing SBFD in a UWB, where the multi-user coordination of the UEs 115 reduces unused frequencies of the UWB spectrum.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of coordinated multi-user dynamic SBFD for UWB as described herein, or the processor 1240 and the memory 1230 may be otherwise configured to perform or support such operations.

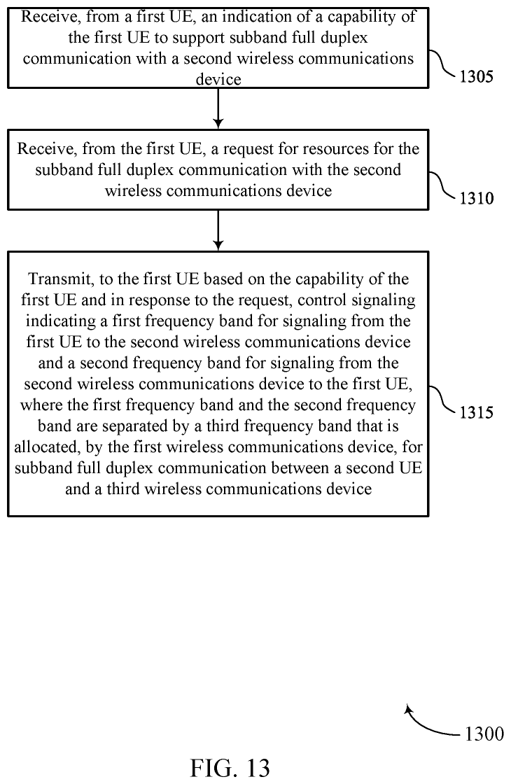

FIG. 13 shows a flowchart illustrating a method 1300 that supports coordinated multi-user dynamic SBFD for UWB in accordance with aspects of the present disclosure. The operations of the method 1300 may be implemented by a network entity or a UE or its components as described herein. For example, the operations of the method 1300 may be performed by a network entity as described with reference to FIGS. 1 through 8 or a UE 115 as described with reference to FIGS. 1 through 4 and 9 through 12. In some examples, a network entity or a UE may execute a set of instructions to control the functional elements of the wireless network entity or the wireless UE to perform the described functions. Additionally, or alternatively, the wireless network entity or the wireless UE may perform aspects of the described functions using special-purpose hardware.

At 1305, the method may include receiving, from a first UE, an indication of a capability of the first UE to support SBFD communication with a second wireless communications device. The operations of 1305 may be performed in accordance with examples as disclosed herein. In some examples, aspects of the operations of 1305 may be performed by an indication reception manager 725 or an indication reception manager 1125 as described with reference to FIGS. 7 and 11.

At 1310, the method may include receiving, from the first UE, a request for resources for the SBFD communication with the second wireless communications device. The operations of 1310 may be performed in accordance with examples as disclosed herein. In some examples, aspects of the operations of 1310 may be performed by a request reception manager 730 or a request reception manager 1130 as described with reference to FIGS. 7 and 11.

At 1315, the method may include transmitting, to the first UE based on the capability of the first UE and in response to the request, control signaling indicating a first frequency band for signaling from the first UE to the second wireless communications device and a second frequency band for signaling from the second wireless communications device to the first UE, where the first frequency band and the second frequency band are separated by a third frequency band that is allocated, by the first wireless communications device, for SBFD communication between a second UE and a third wireless communications device. The operations of 1315 may be performed in accordance with examples as disclosed herein. In some examples, aspects of the operations of 1315 may be performed by a signal transmission manager 735 or a signal transmission manager 1135 as described with reference to FIGS. 7 and 11.

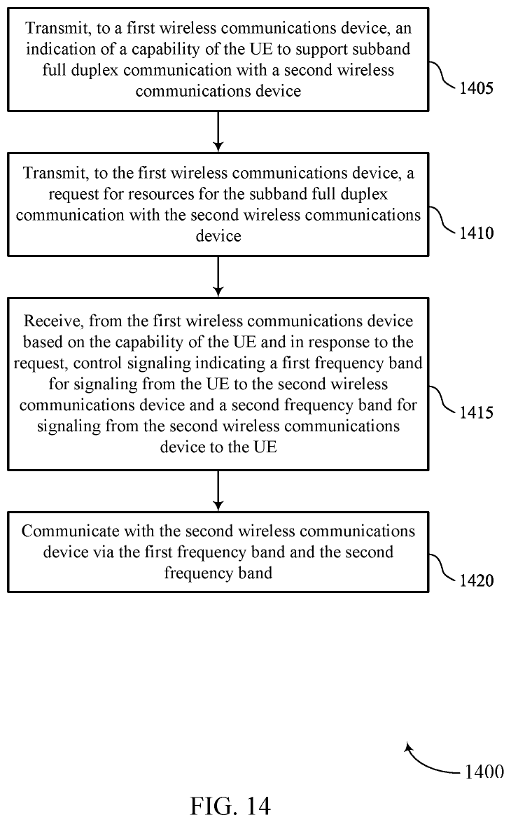

FIG. 14 shows a flowchart illustrating a method 1400 that supports coordinated multi-user dynamic SBFD for UWB in accordance with aspects of the present disclosure. The operations of the method 1400 may be implemented by a UE or its components as described herein. For example, the operations of the method 1400 may be performed by a UE 115 as described with reference to FIGS. 1 through 4 and 9 through 12. In some examples, a UE may execute a set of instructions to control the functional elements of the wireless UE to perform the described functions. Additionally, or alternatively, the wireless UE may perform aspects of the described functions using special-purpose hardware.

At 1405, the method may include transmitting, to a first wireless communications device, an indication of a capability of the UE to support SBFD communication with a second wireless communications device. The operations of 1405 may be performed in accordance with examples as disclosed herein. In some examples, aspects of the operations of 1405 may be performed by an indication transmission manager 1140 as described with reference to FIG. 11.

At 1410, the method may include transmitting, to the first wireless communications device, a request for resources for the SBFD communication with the second wireless communications device. The operations of 1410 may be performed in accordance with examples as disclosed herein. In some examples, aspects of the operations of 1410 may be performed by a request transmission manager 1145 as described with reference to FIG. 11.

At 1415, the method may include receiving, from the first wireless communications device based on the capability of the UE and in response to the request, control signaling indicating a first frequency band for signaling from the UE to the second wireless communications device and a second frequency band for signaling from the second wireless communications device to the UE. The operations of 1415 may be performed in accordance with examples as disclosed herein. In some examples, aspects of the operations of 1415 may be performed by a signal reception manager 1150 as described with reference to FIG. 11.

At 1420, the method may include communicating with the second wireless communications device via the first frequency band and the second frequency band. The operations of 1420 may be performed in accordance with examples as disclosed herein. In some examples, aspects of the operations of 1420 may be performed by a communication manager 1155 as described with reference to FIG. 11.

The following provides an overview of aspects of the present disclosure:
Aspect 1: A method for wireless communication at a first wireless communications device, comprising: receiving, from a first UE, an indication of a capability of the first UE to support SBFD communication with a second wireless communications device; receiving, from the first UE, a request for resources for the SBFD communication with the second wireless communications device; and transmitting, to the first UE based at least in part on the capability of the first UE and in response to the request, control signaling indicating a first frequency band for signaling from the first UE to the second wireless communications device and a second frequency band for signaling from the second wireless communications device to the first UE, wherein the first frequency band and the second frequency band are separated by a third frequency band that is allocated, by the first wireless communications device, for SBFD communication between a second UE and a third wireless communications device.
Aspect 2: The method of aspect 1, further comprising: receiving an indication, from a network entity, that the first wireless communications device is a master UE; and transmitting, in response to receiving the indication that the first wireless communications device is the master UE, a beacon indicating that the first wireless communications device is the master UE, wherein the indication of the capability is received at the first wireless communications device in response to the beacon.
Aspect 3: The method of any of aspects 1 through 2, further comprising: determining that the first wireless communications device is a master UE based at least in part on a failure to detect a beacon from another UE; and transmitting, in response to determining that the first wireless communications device is the master UE, the beacon indicating that the first wireless communications device is the master UE, wherein the indication of the capability is received at the first wireless communications device in response to the beacon.
Aspect 4: The method of any of aspects 1 through 3, further comprising: receiving, from the first UE, an indication of a second capability of the second wireless communications device to support SBFD communication, wherein the control signaling is further based at least in part on the second capability of the second wireless communications device.
Aspect 5: The method of any of aspects 1 through 4, wherein receiving the indication of the capability comprises: receiving an indication of a supported minimum frequency gap for transmission and reception, wherein a frequency separation between the first frequency band and the second frequency band is based at least in part on the supported minimum frequency gap.
Aspect 6: The method of any of aspects 1 through 5, wherein the first wireless communications device is a master UE, and the indication of the capability, the request for resources, and the control signaling are communicated via a licensed sidelink communication link.
Aspect 7: The method of any of aspects 1 through 6, wherein the first wireless communications device is a network entity, and the indication of the capability, the request for resources, and the control signaling are communicated via a licensed access communication link.
Aspect 8: The method of any of aspects 1 through 7, further comprising: receiving, from the second UE, a second indication of a second capability of the second UE to support the SBFD communication with the third wireless communications device; receiving, from the second UE, a second request for resources for communication with the third wireless communications device; and transmitting, to the second UE based at least in part on the second capability of the second UE and in response to the request, control signaling indicating the third frequency band for signaling from the second UE to the third wireless communications device and a fourth frequency band for signaling from the third wireless communications device to the second UE.
Aspect 9: The method of any of aspects 1 through 8, wherein the second wireless communications device comprises an extended reality entity.
Aspect 10: The method of any of aspects 1 through 9, wherein receiving the request comprises: receiving an indication of a relative priority of a combination of the first frequency band and the second frequency band with respect to other combinations of frequency bands, wherein the first frequency band and the second frequency band are based at least in part on the relative priority.
Aspect 11: The method of any of aspects 1 through 10, wherein receiving the request comprises: receiving an indication of a first traffic condition associated with signaling from the first UE to the second wireless communications device and a second traffic condition associated with signaling from the second wireless communications device to the first UE, wherein the first frequency band and the second frequency band are based at least in part on the first traffic condition and the second traffic condition.
Aspect 12: A method for wireless communications at a UE, comprising: transmitting, to a first wireless communications device, an indication of a capability of the UE to support SBFD communication with a second wireless communications device; transmitting, to the first wireless communications device, a request for resources for the SBFD communication with the second wireless communications device; receiving, from the first wireless communications device based at least in part on the capability of the UE and in response to the request, control signaling indicating a first frequency band for signaling from the UE to the second wireless communications device and a second frequency band for signaling from the second wireless communications device to the UE; and communicating with the second wireless communications device via the first frequency band and the second frequency band.
Aspect 13: The method of aspect 12, further comprising: receiving a beacon indicating that the first wireless communications device is a master UE, wherein the indication of the capability is transmitted in response to the beacon.
Aspect 14: The method of any of aspects 12 through 13, further comprising: transmitting, to the first wireless communications device, an indication of a second capability of the second wireless communications device to support SBFD communication, wherein the control signaling is further based at least in part on the second capability of the second wireless communications device.
Aspect 15: The method of aspect 14, further comprising: receiving, from the second wireless communications device, the indication of the second capability.
Aspect 16: The method of any of aspects 12 through 15, wherein transmitting the indication of the capability comprises: transmitting an indication of a supported minimum frequency gap for transmission and reception, wherein a frequency separation between the first frequency band and the second frequency band is based at least in part on the supported minimum frequency gap.
Aspect 17: The method of any of aspects 12 through 16, wherein the first wireless communications device is a master UE, the indication of the capability, the request for resources, and the control signaling are communicated via a licensed sidelink, and the SBFD communication via the first frequency band and the second frequency band are via an ultra wide band communications link.
Aspect 18: The method of any of aspects 12 through 17, wherein the first wireless communications device is a network entity, the indication of the capability, the request for resources, and the control signaling are communicated via a licensed access link, the first wireless communications device is a network entity, and the SBFD communication via the first frequency band and the second frequency band are via an ultra wide band communications link.
Aspect 19: The method of any of aspects 12 through 18, wherein transmitting the request comprises: transmitting an indication of a relative priority of a combination of the first frequency band and the second frequency band with respect to other combinations of frequency bands, wherein the first frequency band and the second frequency band are based at least in part on the relative priority.
Aspect 20: The method of aspect 19, further comprising: performing a channel estimation procedure on a channel between the UE and the second wireless communications device, wherein the relative priority is based at least in part on the channel estimation procedure.
Aspect 21: The method of any of aspects 12 through 20, wherein transmitting the request comprises: transmitting an indication of a first relative traffic condition associated with signaling from the UE to the second wireless communications device and a second relative traffic condition associated with signaling from the second wireless communications device to the UE with respect to other traffic conditions associated with other signaling, wherein the first frequency band and the second frequency band are based at least in part on the first traffic condition and the traffic condition.
Aspect 22: The method of any of aspects 12 through 21, wherein the second wireless communications device comprises an extended reality device.
Aspect 23: A method for wireless communication at a second wireless communications device, comprising: transmitting, to a UE, an indication of a capability of the second wireless communications device to support SBFD communication with the UE; receiving, from the UE based at least in part on the capability of the second wireless communications device, control signaling indicating a first frequency band for signaling from the UE to the second wireless communications device and a second frequency band for signaling from the second wireless communications device to the UE; and communicating with the UE via the first frequency band and the second frequency band.
Aspect 24: The method of aspect 23, wherein transmitting the indication of the capability comprises: transmitting, to the UE, an indication of a supported minimum frequency gap for transmission and reception, wherein a frequency separation between the first frequency band and the second frequency band are based at least in part on the supported minimum frequency gap.
Aspect 25: The method of any of aspects 23 through 24, wherein the indication of the capability and the control signaling are via an unlicensed sidelink communication link and the SBFD communication via the first frequency band and the second frequency band is via an ultra wide band communication link.
Aspect 26: The method of any of aspects 23 through 25, wherein the second wireless communications device comprises an extended reality device.
Aspect 27: The method of any of aspects 23 through 26, wherein the indication of the capability and the control signaling are communicated via a licensed access communication link between the second wireless communication device and the UE.
Aspect 28: An apparatus for wireless communication at a first wireless communications device, comprising a processor; memory coupled with the processor; and instructions stored in the memory and executable by the processor to cause the apparatus to perform a method of any of aspects 1 through 11.
Aspect 29: An apparatus for wireless communication at a first wireless communications device, comprising at least one means for performing a method of any of aspects 1 through 11.
Aspect 30: A non-transitory computer-readable medium storing code for wireless communication at a first wireless communications device, the code comprising instructions executable by a processor to perform a method of any of aspects 1 through 11.
Aspect 31: An apparatus for wireless communications at a UE, comprising a processor; memory coupled with the processor; and instructions stored in the memory and executable by the processor to cause the apparatus to perform a method of any of aspects 12 through 22.
Aspect 32: An apparatus for wireless communications at a UE, comprising at least one means for performing a method of any of aspects 12 through 22.
Aspect 33: A non-transitory computer-readable medium storing code for wireless communications at a UE, the code comprising instructions executable by a processor to perform a method of any of aspects 12 through 22.
Aspect 34: An apparatus for wireless communication at a second wireless communications device, comprising a processor; memory coupled with the processor; and instructions stored in the memory and executable by the processor to cause the apparatus to perform a method of any of aspects 23 through 27.
Aspect 35: An apparatus for wireless communication at a second wireless communications device, comprising at least one means for performing a method of any of aspects 23 through 27.
Aspect 36: A non-transitory computer-readable medium storing code for wireless communication at a second wireless communications device, the code comprising instructions executable by a processor to perform a method of any of aspects 23 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first wireless communications device, comprising:
a processor;
memory coupled with the processor; and
instructions stored in the memory and executable by the processor to cause the first wireless communications device to:
receive, from a first user equipment (UE), an indication of a capability of the first UE to support sub-band full duplex communication with a second wireless communications device;
receive, from the first UE, a request for resources for the subband full duplex communication with the second wireless communications device; and
transmit, to the first UE based at least in part on the capability of the first UE and in response to the request, control signaling indicating a first frequency band for signaling from the first UE to the second wireless communications device and a second frequency band for signaling from the second wireless communications device to the first UE, wherein the first frequency band and the second frequency band are separated by a third frequency band that is allocated, by the first wireless communications device, for the sub-band full duplex communication between a second UE and a third wireless communications device.

2. The first wireless communications device of claim 1, wherein the instructions are further executable by the processor to cause the first wireless communications device to:
receive an indication, from a network entity, that the first wireless communications device is a master UE; and
transmit, in response to receiving the indication that the first wireless communications device is the master UE, a beacon indicating that the first wireless communications device is the master UE, wherein the indication of the capability is received at the first wireless communications device in response to the beacon.

3. The first wireless communications device of claim 1, wherein the instructions are further executable by the processor to cause the first wireless communications device to:
determine that the first wireless communications device is a master UE based at least in part on a failure to detect a beacon from another UE; and transmit, in response to determining that the first wireless communications device is the master UE, the beacon indicating that the first wireless communications device is the master UE, wherein the indication of the capability is received at the first wireless communications device in response to the beacon.

4. The first wireless communications device of claim 1, wherein the instructions are further executable by the processor to cause the first wireless communications device to:
receive, from the first UE, an indication of a second capability of the second wireless communications device to support the sub-band full duplex communication, wherein the control signaling is further based at least in part on the second capability of the second wireless communications device.

5. The first wireless communications device of claim 1, wherein the instructions to receive the indication of the capability are executable by the processor to cause the first wireless communications device to:
receive an indication of a supported minimum frequency gap for transmission and reception, wherein a frequency separation between the first frequency band and the second frequency band is based at least in part on the supported minimum frequency gap.

6. The first wireless communications device of claim 1, wherein: the first wireless communications device is a master UE, and the indication of the capability, the request for resources, and the control signaling are communicated via a licensed sidelink communication link.

7. The first wireless communications device of claim 1, wherein: the first wireless communications device is a network entity, and
the indication of the capability, the request for resources, and the control signaling are communicated via a licensed access communication link.

8-9. (canceled)

10. The first wireless communications device of claim 1, wherein the instructions to receive the request are executable by the processor to cause the first wireless communications device to:
receive an indication of a relative priority of a combination of the first frequency band and the second frequency band with respect to other combinations of frequency bands, wherein the first frequency band and the second frequency band are based at least in part on the relative priority.

11. The first wireless communications device of claim 1, wherein the instructions to receive the request are executable by the processor to cause the first wireless communications device to:
receive an indication of a first traffic condition associated with signaling from the first UE to the second wireless communications device and a second traffic condition associated with signaling from the second wireless communications device to the first UE, wherein the first frequency band and the second frequency band are based at least in part on the first traffic condition and the second traffic condition.

12. A user equipment (UE), comprising:
a processor;
memory coupled with the processor; and
instructions stored in the memory and executable by the processor to cause the UE to:
transmit, to a first wireless communications device, an indication of a capability of the UE to support sub-band full duplex communication with a second wireless communications device;
transmit, to the first wireless communications device, a request for resources for the sub-band full duplex communication with the second wireless communications device;
receive, from the first wireless communications device based at least in part on the capability of the UE and in response to the request, control signaling indicating a first frequency band for signaling from the UE to the second wireless communications device and a second frequency band for signaling from the second wireless communications device to the UE; and communicate with the second wireless communications device via the first frequency band and the second frequency band.

13. The UE of claim 12, wherein the instructions are further executable by the processor to cause the UE to:
receive a beacon indicating that the first wireless communications device is a master UE. wherein the indication of the capability is transmitted in response to the beacon.

14. The UE of claim 12, wherein the instructions are further executable by the processor to cause the UE to:
transmit, to the first wireless communications device, an indication of a second capability of the second wireless communications device to support the subband full duplex communication, wherein the control signaling is further based at least in part on the second capability of the second wireless communications device.

15. The UE of claim 14, wherein the instructions are further executable by the processor to cause the UE to:
receive, from the second wireless communications device, the indication of the second capability.

16. The UE of claim 12, wherein the instructions to transmit the indication of the capability are executable by the processor to cause the UE to:
transmit an indication of a supported minimum frequency gap for transmission and reception, wherein a frequency separation between the first frequency band and the second frequency band is based at least in part on the supported minimum frequency gap.

17. The UE of claim 12, wherein: the first wireless communications device is a master UE, the indication of the capability, the request for resources, and the control signaling are communicated via a licensed sidelink, and
the sub-band full duplex communication via the first frequency band and the second frequency band are via an ultra wide band communications link.

18. The UE of claim 12, wherein: the first wireless communications device is a network entity, the indication of the capability, the request for resources, and the control signaling are communicated via a licensed access link, and
the sub-band full duplex communication via the first frequency band and the second frequency band are via an ultra wide band communications link.

19. The UE of claim 12, wherein the instructions to transmit the request are executable by the processor to cause the UE to:
transmit an indication of a relative priority of a combination of the first frequency band and the second frequency band with respect to other combinations of frequency bands, wherein the first frequency band and the second frequency band are based at least in part on the relative priority.

20-27. (canceled)

28. A method for wireless communication at a first wireless communications device, comprising:
receiving, from a first user equipment (UE), an indication of a capability of the first UE to support sub-band full duplex communication with a second wireless communications device;
receiving, from the first UE, a request for resources for the sub-band full duplex communication with the second wireless communications device; and
transmitting, to the first UE based at least in part on the capability of the first UE and in response to the request, control signaling indicating a first frequency band for signaling from the first UE to the second wireless communications device and a second frequency band for signaling from the second wireless communications device to the first UE, wherein the first frequency band and the second frequency band are separated by a third frequency band that is allocated, by the first wireless communications device, for the sub-band full duplex communication between a second UE and a third wireless communications device.

29. The method of claim 28, further comprising:
receiving an indication, from a network entity, that the first wireless communications device is a master UE; and
transmitting, in response to receiving the indication that the first wireless communications device is the master UE, a beacon indicating that the first wireless communications device is the master UE, wherein the indication of the capability' is received at the first wireless communications device in response to the beacon.

30. The method of claim 28, further comprising:
determining that the first wireless communications device is a master UE based at least in part on a failure to detect a beacon from another UE; and transmitting, in response to determining that the first wireless communications device is the master UE, the beacon indicating that the first wireless communications device is the master UE, wherein the indication of the capability′ is received at the first wireless communications device in response to the beacon.
